(19) United States
(12) Patent Application Publication
(10) Pub. No.: US 2012/0003460 A1
(43) Pub. Date: Jan. 5, 2012

(54) Two-Layer Porous Layer System Having a Pyrochlore Phase

(76) Inventor: Werner Stamm, Mulheim an der Ruhr (DE)

(21) Appl. No.: 13/256,373

(22) PCT Filed: Mar. 8, 2010
(86) PCT No.: PCT/EP2010/052879

§ 371 Date: Sep. 13, 2011

(30) Foreign Application Priority Data
Mar. 18, 2009 (EP) 090039108

(51) Int. Cl. B32B 18/00; B32B 5/22

(52) U.S. Cl. 428/220; 428/312.8

(57) ABSTRACT

Heat-insulating layer systems must have a long service life of the heat-insulating layer in addition to a good heat-insulating property. A layer system including a sequence of layers specially matched to each other, the sequence including metallic connection layer, an inner ceramic layer, and an outer ceramic layer is provided.

### CROSS REFERENCE TO RELATED APPLICATIONS

This application is the US National Stage of International Application No. PCT/EP2010/052879, filed Mar. 8, 2010 and claims the benefit thereof. The International Application claims the benefits of European Patent Office application No. 09003910.8 EP filed. Mar. 18, 2009. All of the applications are incorporated by reference herein in their entirety.

### FIELD OF INVENTION

The invention relates to a layer system with pyrochlores as claimed in the claims

### BACKGROUND OF INVENTION

Such a layer system has a substrate comprising a metal alloy based on nickel or cobalt. Such products are used especially as a component of a gas turbine, in particular as gas turbine blades or heat shields. The components are exposed to a hot gas flow of aggressive combustion gases. They must therefore be able to withstand heavy thermal loads. It is furthermore necessary for these components to be oxidation- and corrosion-resistant. Especially moving components, for example gas turbine blades, but also static components, are furthermore subject to mechanical requirements. The power and efficiency of a gas turbine, in which there are components exposable to hot gas, increase with a rising operating temperature. In order to achieve a high efficiency and a high power, those gas turbine components which are particularly exposed to high temperatures are coated with a ceramic material. This acts as a thermal insulation layer between the hot gas flow and the metallic substrate.

The metallic base body is protected against the aggressive hot gas flow by coatings. In this context, modern components usually comprise a plurality of coatings which respectively fulfill specific functions. The system is therefore a multilayer system.

Since the power and efficiency of gas turbines increase with a rising operating temperature, attempts are continually being made to achieve a higher performance of gas turbines by improving the coating system.

EP 0 944 746 B1 discloses the use of pyrochlores as a thermal insulation layer. The use of a material as a thermal insulation layer, however, requires not only good thermal insulation properties but also good bonding to the substrate.

EP 0 992 603 A1 discloses a their al insulation layer system of gadolinium oxide and zirconium oxide, which is not intended to have a pyrochlore structure.

### SUMMARY OF INVENTION

It is therefore an object of the invention to provide a layer system which has good thermal insulation properties and good bonding to the substrate, and therefore a long lifetime of the entire layer system.

The object is achieved by a layer system as claimed in the claims.

The dependent claims describe further advantageous measures, which may advantageously be combined in any desired way in order to achieve further advantages.

The invention is based on the discovery that in order to achieve a long lifetime, the entire system must be considered as a whole and individual layers or some layers together should not be considered and optimized separately from one another.

### BRIEF DESCRIPTION OF THE DRAWINGS

FIG. 1 shows a layer system according to the invention,

FIG. 2 shows a list of superalloys,

FIG. 3 shows a perspective view of a turbine blade,

FIG. 4 shows a perspective view of a combustion chamber,

FIG. 5 shows a gas turbine.

The figures and the description merely represent exemplary embodiments.

### DETAILED DESCRIPTION OF INVENTION

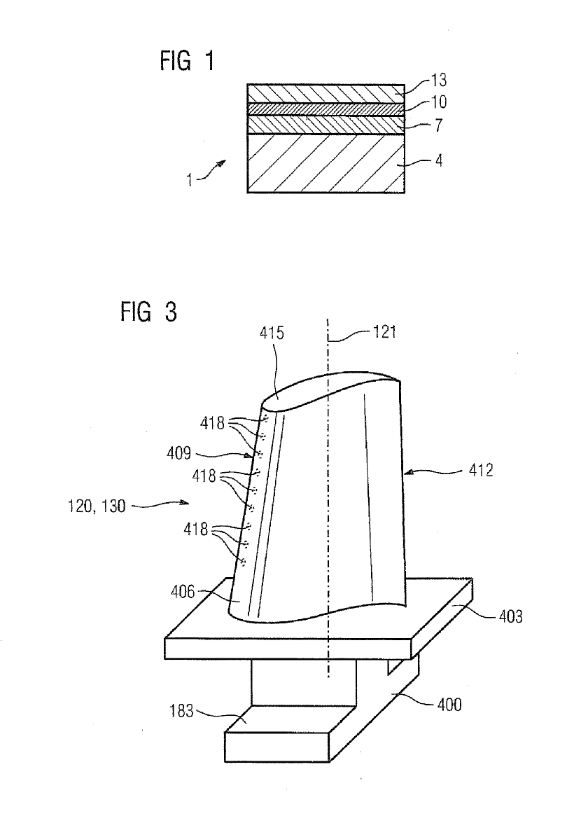

FIG. 1 shows a layer system 1 according to the invention.

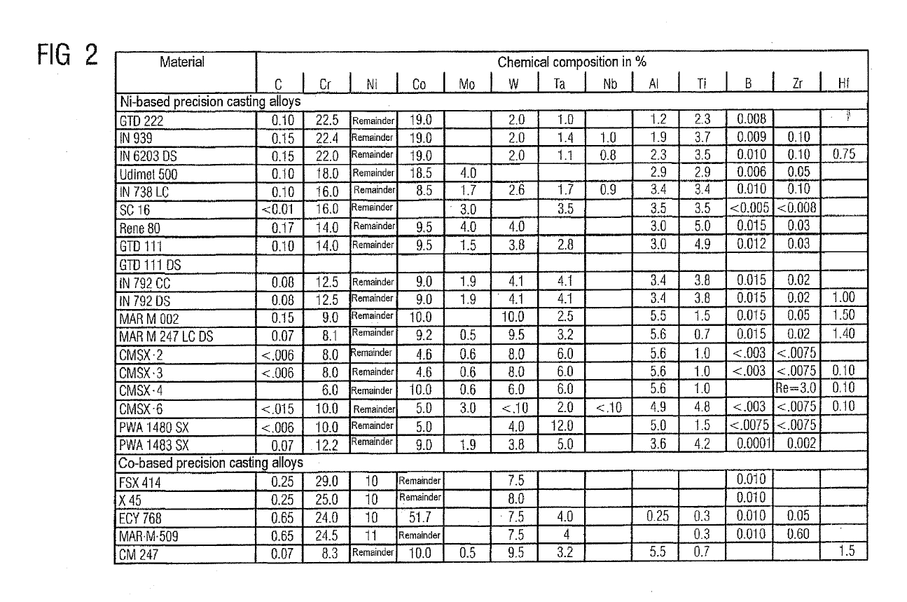

The layer system 1 comprises a metallic substrate 4 which, in particular for components at high temperatures, comprises a nickel- or cobalt-based superalloy (FIG. 2) and very particularly consists thereof.

In particular, only one metallic layer 7 with only one composition is present. A two-layer metallic layer 7 is also preferably conceivable, but not a multilayer system of alternating metallic and/or ceramic layers.

Directly on the substrate 4, there is preferably a metallic bonding layer 7, in particular of the NiCoCrAlX type, which preferably comprises (11-13) wt % cobalt, (20-22) wt % chromium, (10.5-11.5) wt % aluminum, (0.3-0.5) wt % yttrium, (1.5-2.5) wt % rhenium and nickel, or preferably (24-26) wt % cobalt, (16-18) wt % chromium, (9.5-11) wt % aluminum, (0.3-0.5) wt % yttrium, (1.0-1.8) wt % rhenium and remainder nickel and in particular consists in each case of these listed elements.

Directly on the substrate 4, there is likewise preferably a metallic bonding layer 7, in particular of the NiCoCrAlX type, which preferably comprises 26%-30% nickel, in particular 28% nickel, 20%-28% chromium, in particular 24% chromium, 8%-12% aluminum, in particular 10% aluminum, 0.1%-3% yttrium, in particular 0.6% yttrium and cobalt (in wt %), in particular consists thereof, or the metallic bonding layer 7 represents a two-layer metallic layer with various compositions, in particular with an outer β-NiAl layer, and in particular consists of two metallic layers.

An aluminum oxide layer is preferably formed already on this metallic bonding layer 7 before further ceramic layers are applied, or such an aluminum oxide layer (TGO) is formed during operation.

There is generally an inner ceramic layer 10, preferably a fully or very preferably partially stabilized zirconium oxide layer, on the metallic bonding layer 7 or on the aluminum oxide layer (not shown). Yttrium-stabilized zirconium oxide (YSZ) is preferably used, with 6 wt %-8 wt % of yttrium preferably being employed. Calcium oxide, cerium oxide and/or hafnium oxide may likewise be used to stabilize zirconium oxide.

The zirconium oxide is preferably applied as a plasma-sprayed layer (APS, LPPS, VPS, . . . ), although it may also preferably be applied as a columnar structure by means of electron beam deposition (EBPVD).

An outer ceramic layer 13 which consists mainly of a pyrochlore phase, i.e. it comprises at least 90 wt % of the pyrochlore phase that comprises either gadolinium hafnate (GHO), in particular Gd₂Hf₂O₇, or gadolinium zirconate (GZO), in particular Gd₂Zr₂O₇, in particular consists thereof, is applied on the stabilized zirconium oxide layer 10.

Preferably at least 98 wt % of the outer layer 13 consists of one of the two pyrochlore phases. Amorphous phases, pure GdO₂, pure ZrO₂ or pure HfO₂, mixed phases of GdO₂ and ZrO₂ or HfO₂, which do not comprise the pyrochlore phase, are in this case undesirable and should be minimized.

The porosity of the inner layer 10 is preferably 10 vol % and very preferably up to 18 vol %, very preferably 12 vol % to 16 vol %.

The porosity of the outer ceramic layer 13 is likewise preferably greater than that of the inner layer 10 and is >20 vol %, preferably >21 vol % and preferably up to 28 vol %.

Just like the TGO (aluminum oxide layer) on the metallic bonding layer, the inner layer 10 serves as a bonding layer and, like the TGO, has a dense configuration in the prior art also on account of the mechanical stability. Therefore, it is very surprising to design the inner ceramic bonding layer 10 in porous form. Long lifetimes of the ceramic layer are thus achieved because spalling of the outer ceramic layer 13 rarely occurs. This is particularly important in the case of thick ceramic two-layer layers.

The ceramic layer 13 is preferably the outermost layer, which is exposed directly to the hot gas from a gas turbine 100.

The layer thickness of the inner layer 10 is preferably between 10% and 50% of the total layer thickness of the inner layer 10 plus the outer layer 13.

The layer thickness of the inner layer 10 is preferably between 10% and 40% or between 10% and 30% of the total layer thickness.

It is likewise advantageous for the layer thickness of the inner layer 10 to comprise from 10% to 20% of the total layer thickness.

It is likewise preferable for the layer thickness of the inner layer 10 to be between 20% and 50% or between 20% and 40% of the total layer thickness.

Advantageous results are likewise achieved if the contribution of the inner layer 10 to the total layer thickness is between 20% and 30%.

The layer thickness of the inner layer 10 is preferably from 30% to 50% of the total layer thickness.

It is likewise advantageous for the layer thickness of the inner layer 10 to comprise from 30% to 40% of the total layer thickness.

It is likewise preferable for the layer thickness of the inner layer 10 to be between 40% and 50% of the total layer thickness.

The inner ceramic layer 10 preferably has a thickness of from 40 μm to 60 μm, in particular 50 μm±10%.

The total layer thickness of the inner layer 10 plus the outer layer 13 is preferably 300 μm or preferably 400 μm. The maximum total layer thickness is advantageously 800 μm or preferably at most 600 μm.

Although the pyrochlore phase has better thermal insulation properties than the ZrO₂ layer, the ZrO₂ layer may be configured to be just as thick as the pyrochlore phase.

Particularly good results are achieved if the layer system consists of a substrate of a metallic bonding layer, in particular an NiCoCrAlX layer, optionally a TGO, of an inner zirconium oxide layer and an outer layer of a pyrochlore phase (GZO or GHO).

FIG. 3 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a blade surface 406.

As a guide vane 130, the vane 130 may have a further platform (not shown) at its vane tip 415.

A blade root 183 which is used to fasten the rotor blades 120, 130 on a shaft or a disk (not shown) is formed in the fastening zone 400.

The blade root 183 is configured, for example, as a hammerhead. Other configurations as a firtree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A1, WO 99/67435 or WO 00/44949.

The blades 120, 130 may in this case be manufactured by a casting method, also by means of directional solidification, by a forging method, by a machining method or combinations thereof.

Workpieces with a monocrystalline structure or structures are used as components for machines which are exposed to heavy mechanical, thermal and/or chemical loads during operation.

Such monocrystalline workpieces are manufactured, for example, by directional solidification from the melts. These are casting methods in which the liquid metal alloy is solidified to form a monocrystalline structure, i.e. to form the monocrystalline workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or monocrystalline component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. No. 6,024,792 and EP 0 892 090 A1.

The blades 120, 130 may likewise have coatings against corrosion or oxidation, for example (MCrAlX; M is at least one element from the group ion (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1.

On the MCrAlX layer, there may furthermore be a ceramic thermal insulation layer 13 according to the invention.

Rod-shaped grains are produced in thermal insulation layer by suitable coating methods, for example electron beam deposition (EB-PVD).

Refurbishment means that components 120, 130 may need to have protective layers taken off (for example by sandblasting) after their use. Then the corrosion and/or oxidation layers or products are removed. Optionally, cracks in the component 120, 130 are also repaired. The component 120, 130 is then recoated and the component 120, 130 is used again.

The blade 120, 130 may be designed to be a hollow or solid.

If the blade 120, 130 is intended to be cooled, it will be hollow and optionally also comprise film cooling holes 418 (indicated by dashes).

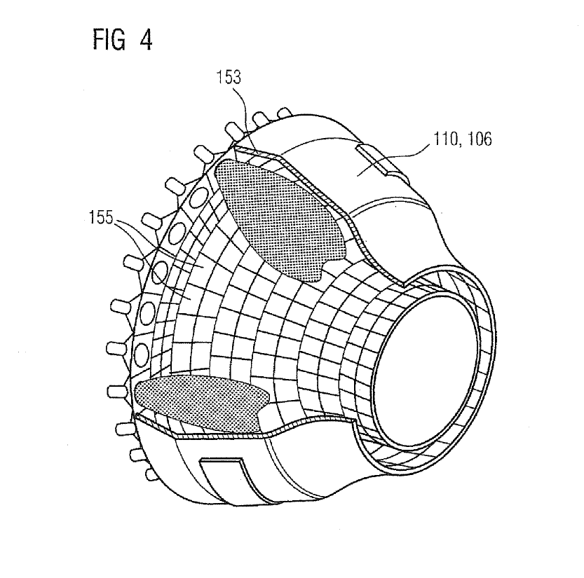

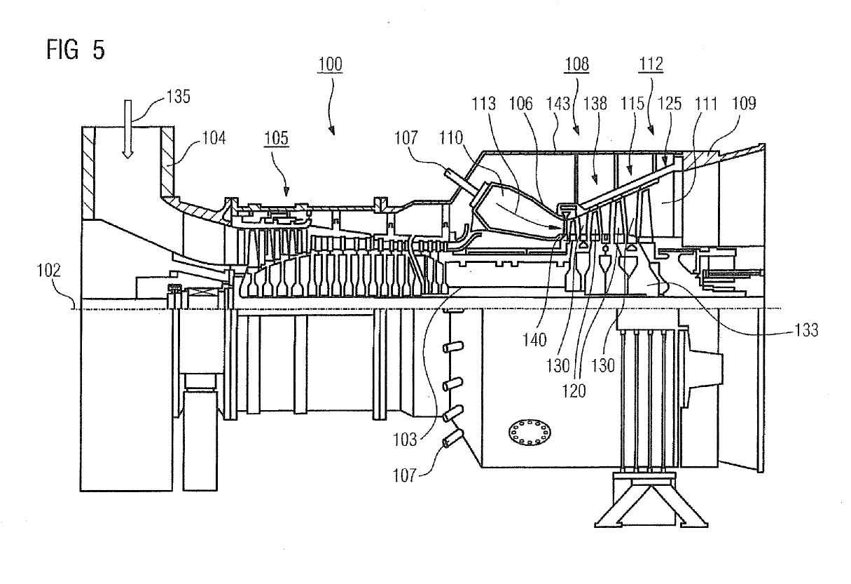

FIG. 4 shows a combustion chamber 110 of a gas turbine 100 (FIG. 5).

The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Each heat shield element 155 made of an alloy is equipped with a particularly heat-resistant protective layer (MCrAlX layer and/or ceramic coating) on the working medium side, or is made of refractory material (solid ceramic blocks).

These protective layers may be similar to the turbine blades, i.e. for example MCrAlX means: M is at least one element from the group ion (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306 454 A1.

Refurbishment means that heat shield elements 155 may need to have protective layers taken off (for example by sandblasting) after their use. The corrosion and/or oxidation layers or products are then removed. Optionally, cracks in the heat shield element 155 are also repaired. The heat shield elements 155 are then recoated and the heat shield elements 155 are used again.

Owing to the high temperatures inside the combustion chamber 110, a cooling system may also be provided for the heat shield elements 155 or for their retaining elements. The heat shield elements 155 are then hollow, for example, and optionally also have film cooling holes (not shown) opening into the combustion chamber space 154.

FIG. 5 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108.

Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fastened on the rotor 103, for example by means of a turbine disk 133.

Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant.

Substrates of the components may likewise comprise a directional structure, i.e. they are monocrystalline (SX structure) or comprise only longitudinally directed grains (DS structure).

Iron-, nickel- or cobalt-based superalloys are for example used as material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

1.-15. (canceled)

16. A layer system, consisting of:
a substrate;
a metallic bonding layer which comprises an NiCoCrAlX alloy;
an inner ceramic layer on the metallic bonding layer, the inner layer comprises an yttrium-stabilized zirconium oxide layer; and
an outer ceramic layer on the inner ceramic layer, the outer layer comprises at least 90 wt % of a pyrochlore phase gadolinium zirconate, wherein a first porosity of the inner layer is at least 10 vol %.

17. The layer system as claimed in claim 16, wherein a second porosity of the outer layer is >20 vol %.

18. The layer system as claimed in claim 17, wherein the second porosity of the outer layer is up to 28 vol %.

19. The layer system as claimed in claim 16, wherein the inner layer includes a layer thickness of between 10% and 50%, of a total layer thickness of the inner layer plus the outer layer.

20. The layer system as claimed in claim 16, wherein the inner layer includes a layer thickness of from 40 μm to 60 μm.

21. The layer system as claimed in claim 16,
wherein the metallic bonding layer includes the composition (in wt %)
11%-13% cobalt,
20%-22% chromium,
10.5%-11.5% aluminum,
0.3%-0.5% yttrium,
1.5%-2.5% rhenium, and
nickel.

22. The layer system as claimed in claim 16, wherein only two ceramic layers are present.

23. The layer system as claimed in claim 16, wherein a total layer thickness is at most 800 μm.

24. The layer system as claimed in claim 16 consisting of:
the substrate;
the metallic bonding layer of only one composition;
the inner ceramic layer;
the outer ceramic layer; and
a TGO on the bonding layer.

25. The layer system as claimed in claim 17,
wherein a second porosity of the outer layer is 22 vol % to 28 vol %.

26. The layer system as claimed in claim 16, wherein the metallic bonding layer consists of a NiCoCrAlX alloy.

27. A layer system, consisting of:
a substrate;
a metallic bonding layer which comprises an NiCoCrAlX alloy;
an inner ceramic layer on the metallic bonding layer;
an outer ceramic layer on the inner ceramic layer, the outer ceramic layer comprises at least 90 wt % of a pyrochlore phase gadolinium zirconate,
wherein a first porosity of the outer layer is >20 vol %.

28. The layer system as claimed in claim 27, wherein a second porosity of the inner layer is 10 vol %.

29. The layer system as claimed in claim 28, wherein the second porosity of the inner layer is up to 18 vol %.

30. The layer system as claimed in claim 27, wherein the metallic bonding layer includes the composition (in wt %)
24%-26% cobalt,
16%-18% chromium,
9.5%-11% aluminum,
0.3%-0.5% yttrium,
1.0%-1.8% rhenium, and
nickel.

31. The layer system as claimed in claim 27, wherein the metallic bonding layer includes the composition (in wt %)
26%-30% nickel,
20%-28% chromium,
8%-12% aluminum,
0.1%-3% yttrium, and
cobalt.

32. The layer system as claimed in claim 27, wherein a total layer thickness of the inner layer plus the outer layer is at most 400 μm.

33. The layer system as claimed in claim 27, wherein a second porosity of the inner layer is 12 vol % to 16 vol %.

34. The layer system as claimed in claim 27, wherein the metallic bonding layer consists of a NiCoCrAlX alloy.

35. A layer system, consisting of:
a substrate;
a metallic bonding layer which comprises an NiCoCrAlX alloy;
an inner ceramic layer on the metallic bonding layer which comprises an yttrium-stabilized zirconium oxide layer; and
an outer ceramic layer on the inner ceramic layer which comprises at least 90 wt % of the pyrochlore phase gadolinium hafnate,
wherein a porosity of the inner layer is at least 10 vol %.
